(19) United States
(12) Patent Application Publication
(10) Pub. No.: US 2007/0199433 A1
(43) Pub. Date: Aug. 30, 2007

(54) Fiddolin

(76) Inventor: Clennon Wayne Jerrolds, Hardin County, TN (US)

Correspondence Address: Charles F. Rye, Fifth Floor, 8 South Third Street, Memphis, TN, 38103, US

(21) Appl. No.: 11/363,981

(22) Filed: Feb. 28, 2006

(51) Int. Cl. G10H 3/00; G10H 1/32

(52) U.S. Cl. 84/743

(57) ABSTRACT

A stringed musical instrument combination of at least two traditional stringed musical instruments or of nontraditional stringed musical instruments or a mix of traditional and nontraditional. The combination presents the advantages of rapid exchange while playing, reduced storage or transportation volume and a lower cost than two separate instruments. The preferred embodiment is a Fiddolin, a commercially available violin modified to present a mandolin on its back face. The string tension requirement is solved by having additional structure to mount the mandolin pegs into and the angularity needed to keep the strings pulled over the nut by channels or lumens to conduct the strings through.

### BACKGROUND OF THE INVENTION

1. Introduction

This invention relates to stringed musical instruments. A combination of two or more instruments favored by the player resulting in rapid change of instruments while playing, reduced storage volume and lower cost. Many musicians branch out as they gain expertise with one instrument and desire to play other instruments. Many musical accompaniments use different stringed instruments played at different times. When the performer is a singer playing an instrument allows the singer to set the tempo of the music which is more discernable on a plucked instrument such as a mandolin. The violin gives the performer a separate instrument to play during instrumental breaks in the lyrics. The preferred embodiment of this invention is of a commercially available violin with added fixtures that transform the back of the violin body into a mandolin. The invention further includes a hook/holster generally hung from the player's belt line to hold the violin bow when it is not needed.

2. Prior Art

Combinations of stringed musical instruments are very old in the art. U.S. Pat. No. 832,157 issued to Platis in 1906 teaches a mandolin arm bolted to the face of a guitar. The body of a guitar is several times the volume of a standard mandolin, the quality of the connection to the guitar body, the position on the sounding body and other factors affect the quality of sound produced. The overall size of the instrument affects the player's ability to manipulate it as a mandolin.

U.S. Pat. No. 1,554,806 issued to Furia in 1925 describes a banjo with an additional neck extending from its back at an acute angle to the banjo neck with other necessary fixtures to create a mandolin on that surface. The banjo relies on a drum like head on which the bridge rests to define and amplify its sound. The resonance from that combination would differ from a hollow wooden body. The neck positions would also restrict quick manipulation from one instrument to the other and involve an awkward case.

U.S. Pat. No. 3,130,625 issued to Savona in 1964 describes a modular electric guitar that accepts more than one instrument in the form of detachable arms. That patent cites it usefulness as applied to instruments that are also equipped with electrical pickups. Savona also cites the body being acoustical however the sound quality would be affected by the position of the instrument arm and the quality of the attachment.

U.S. Pat. No. 3,636,809 issued to Ezaki in 1972 describes a two neck acoustic guitar. The necks support each other for a thinner structure but would interfere with reaching over the topside to cord with the thumb. That design does not include accommodating a string path in the head that cross for each instrument to allow a narrow neck near the head.

Other variations exist that address different feature: U.S. Pat. No. 4,953,434 dual chambers rotatable with opposing necks; U.S. Pat. No. 4,981,063 four sided electric guitar arm; U.S. Pat. No. 4,987,815 electric guitar mounted on acoustic body; U.S. Pat. No. 5,212,329 detachable electric guitar mounted on saddle of acoustic body; U.S. Pat. No. 5,571,980 floor mounted support for dual instrument; U.S. Pat. No. 6,649,818 U shaped solid body electric guitar and many other variations. Each of these has attributes and limitations but do not fulfill the usefulness of the present invention.

### SUMMARY OF THE INVENTION

This invention preferred embodiment is a violin modified with added fixtures on its back to create a mandolin side. The general configuration and size of these two instruments complement into a single instrument. If the player desires, a sharper tone is created by modifying a mandolin with fixtures to a violin on the back side. The traditional curvilinear body of each instrument naturally lends itself toward the neck thicknesses merging at about the head. This results in a neck that the average player can comfortably reach around to cord either instrument. The hand position would also naturally mute the strings of the instrument not being played. The invention further includes a hook/holster generally hung from the player's belt line to hold the violin bow when it is not needed.

### BRIEF DESCRIPTION OF THE DRAWINGS

FIG. 1. is a front view of the violin.

FIG. 2. is a side view of the combined instrument.

FIG. 3. is a back view of the combined instrument which is the mandolin.

### DETAILED DESCRIPTION OF THE DRAWINGS

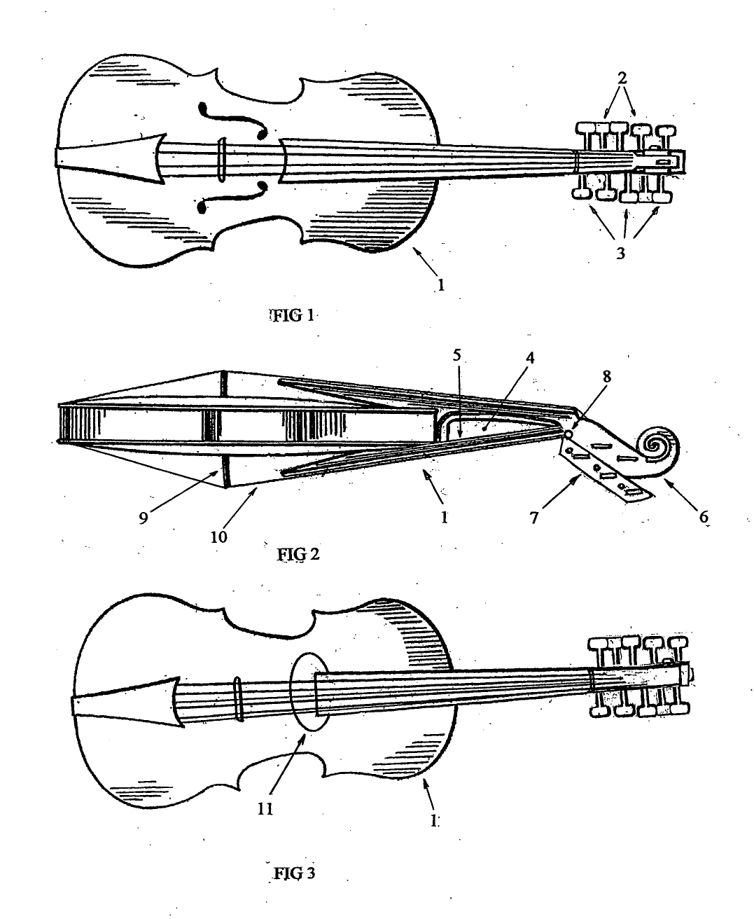

FIG. 1. shows a front view of a commercially available violin with its standard features which has been modified into a Fiddolin 1. Also shown in this view are the four standard violin tuning pegs 2 and six mandolin tuning pegs 3.

FIG. 2. shows a side view of the Fiddolin 1. Neck adaptor 4 supports mandolin finger board 5. Violin head 6 has been modified to receive mandolin head section 7 which further houses six mandolin tuning pegs 3 and recurve nut 8. Mandolin bridge 9 is of sufficient height to keep mandolin strings 10 generally parallel to mandolin finger board 5.

FIG. 3. shows a front view of the mandolin side of the Fiddolin 1. Mandolin sounding hole 11 is also shown.

The preferred embodiment of this invention has been portrayed in the description and drawings and is not intended as a limitation on other adaptations of this invention. Those skilled in the art can envision various adaptations of this invention to accommodate other conductor terminations both temporary and permanent which would benefit from the use of this invention.

I claim:

1. A stringed musical instrument comprising a combination of at least two traditional stringed musical instrument configurations further comprising;
a body portion, at least one neck, head, adjustable string receivers, nuts, finger boards, strings, bridges, string anchors;
Said body comprising a hollow body having at least a first body side and a second body side;
said neck secured to and radiating outwardly from said hollow body;
said neck having a first finger board face and a second finger board face each generally defining a plane respectively oriented with said first and second body side;
said first body side further comprising;
a first string anchor mounted to said first body side opposite said neck, at least one string, first bridge, first finger board, first side nut, first head section and an adjustable string receiver for each string generally configured as a first traditional stringed instrument;
said first body side defining at least one first body side sounding hole;
said first finger board affixed to said first finger board face fretted or unfretted as dictated by said first traditional stringed instrument configuration;
said first side nut affixed to said first finger board face distal to said hollow body;
said first bridge located on said first body side at a predetermined position its distance from said first nut defining the free playing length of said strings;
said first bridge is of sufficient height in conjunction with said first side nut to hold strings above and generally parallel to said first finger board;
said second body side generally comprising the features of said first body side generally in the configuration of a second traditional stringed musical instrument;
the plane defined by said second finger board face generally forms an acute angle to the plane defined by said second finger board face;
said first head section and said second head section adjoined form said head and are affixed or unitary to said neck distal to said hollow body;
Said adjustable string receivers are mounted in their respective head sections and generally below the plane defined by their respective finger board face;
said head sections further defining channels and or lumens which conduct said strings from their respective nut to their respective adjustable string receiver; and
said strings are connected to their respective string anchors and stretched across their respective bridges and nuts by tension created by its respective adjustable string receiver manipulated to create the desired tone tension.

2. the stringed musical instrument of claim 1 further comprising at least one recurve nut mounted proximal to said nut accommodating a change in the string path from said nut to said adjustable string receiver.

3. the stringed musical instrument of claim 1 wherein said combination includes at least one non-traditional stringed musical instrument configuration.

4. The stringed musical instrument of claim 1 further comprising at least one non acoustic pickup

5. The stringed musical instrument of claim 1 further comprising at least one acoustic pickup

6. The stringed musical instrument of claim 1 further comprising said body being partially hollow

7. The stringed musical instrument of claim 1 further comprising said body being solid.

8. The stringed musical instrument of claim 1 further comprising at least one stringed musical instrument configuration which dictates the player to use a hand held facilitator further comprising a clip and hook/holster remove-ably affixed on an article of clothing worn by the player which holds the facilitator when it is not required.

9. The stringed musical instrument of claim 1 further comprising at least one stringed musical instrument configuration which requires the player to use a bow further comprising a clip and hook/holster mounted on an article of clothing worn by the player which holds the bow when it is not required.

10. A stringed musical instrument combination of two traditional stringed musical instruments generally having at least a body and neck comprising;
a first stringed musical instrument comprising the structure of a preexisting stringed musical instrument and a second stringed musical instrument configuration comprising;
a neck adaptor adaptive to and affixed to the back of said first stringed musical instrument neck having a second finger board face opposite said first stringed musical instrument finger board;
a second finger board affixed to said second finger board face fretted or unfretted as dictated by said second musical instrument configuration;
a nut affixed to said second finger board distal to said first stringed musical instrument body;
a second head section adaptive to and affixed to said first stringed musical instrument head adaptive to receive adjustable string receivers;
an adjustable string receiver for each string;
a bridge mounted on the back of said first stringed musical instrument at a predetermined position its distance from said nut defining the free playing length of said strings;
a string anchor affixed to the back of said first stringed musical instrument opposite said neck;
said second head section and first stringed musical instrument head defining channels and or lumens to conduct strings from their respective nut to their respective adjustable string receivers;
the back of said first stringed musical instrument body defining at least one sounding hole and further defining a reduced area to accommodate reducing the angle of said second finger board relative to said preexisting stringed musical instrument's finger board; and
said strings are connected to their respective string anchors and stretched across their respective bridges and nuts by tension created by its respective adjustable string receiver manipulated to create the desired tone tension.

11. The stringed musical instrument of clam 10 wherein said first stringed musical instrument comprising a violin and said second stringed musical instrument configuration comprising a mandolin.

12. The stringed musical instrument of claim 10 wherein said first stringed musical instrument comprising a violin and said second stringed musical instrument configuration of a mandolin having at least one less string than traditional for mandolins.

13. The stringed musical instrument of claim 10 wherein said first stringed musical instrument comprising a violin and said second stringed musical instrument configuration of a mandolin having only one G string and one D string.

14. The stringed musical instrument of claim 10 further comprising a clip and hook/holster removeable affixed on an article of clothing worn by the player which holds the bow when it is not required.

15. The stringed musical instrument of claim 10 further comprising;
At least one tune-able string anchor affixed to a body side opposite its respective neck;
At least one distal string anchor affixed to said neck distal to said body and said nut; and
Said tune-able string anchor further comprising an adjustable string retainer for each respective string.

16. A stringed musical instrument combination of a violin and a mandolin comprising;
the structure of a preexisting violin and;
a neck adaptor adaptive to and affixed to the back of said violin neck having a second finger board face opposite said violin finger board;
a fretted finger board affixed to said second finger board face;
a nut affixed to said fretted finger board distal to said violin body;
a second head section adaptive to and affixed to said violin head adaptive to receive adjustable string receivers;
an adjustable string receiver for each string;
a bridge mounted on the back of said violin at a predetermined position its distance from said nut defining the free playing length of said strings;
a string anchor affixed to the back of said violin opposite said neck;
said second head section and violin head defining channels and or lumens to conduct strings from their respective nut to their respective adjustable string receivers;
the back of said violin body defining at least one sounding hole and further defining a reduced area to accommodate reducing the angle of said second finger board relative to said violin's finger board;
strings including two E, two A, one D and one E;
said strings are connected to their respective string anchors and stretched across their respective bridges and nuts by tension created by its respective adjustable string receiver manipulated to create the desired tone tension; and
a clip and hook/holster remove-able affixed on an article of clothing worn by the player which holds the bow when it is not required.

17. The stringed musical instrument of claim 16 further comprising;
a tune-able string anchor affixed to the back of said violin opposite its respective neck;
a distal string anchor affixed to said neck replacing said second head section; and
Said tune-able string anchor further comprising an adjustable string retainer for each respective string.
